(19) United States
(12) Patent Application Publication
(10) Pub. No.: US 2024/0001493 A1
(43) Pub. Date: Jan. 4, 2024

(54) LASER MACHINING HEAD WITH OVERHEAT PROTECTION DEVICE

(71) Applicant: Precitec GmbH & Co. KG, Gaggenau (DE)

(72) Inventors: Tom WALDE, Offenburg (DE); Rüdiger MOSER, Malsch (DE)

(21) Appl. No.: 18/346,611

(22) Filed: Jul. 3, 2023

(30) Foreign Application Priority Data
Jul. 1, 2022 (DE) 10 2022 116 491.8

(51) Int. Cl. B23K 37/00; B23K 26/70; B23K 26/082

(52) U.S. Cl. CPC B23K 37/006; B23K 26/703; B23K 26/704; B23K 26/082

(57) ABSTRACT

A laser machining head for machining a workpiece by a laser beam includes: a scanning device for deflecting the laser beam on the workpiece; a housing in which the scanning device is arranged; and at least one overheat protection device configured to protect the housing from overheating, said overheat protection device comprising an energy distribution device for distributing incident radiation energy and/or a heat sink for dissipating heat.

### CROSS-REFERENCE TO RELATED APPLICATION

This application claims priority to German Patent Application No. 10 2022 116 491.8, filed Jul. 1, 2022, which is hereby incorporated by reference in its entirety.

### FIELD OF THE INVENTION

The present disclosure relates to a laser machining head for machining a workpiece using a laser beam with at least one overheat protection device which protects, for example, the housing of the laser machining head (in particular a scanner housing) and/or components of the laser machining head arranged in the housing from overheating, in particular from overheating due to laser radiation.

### BACKGROUND OF THE INVENTION

In a laser machining head for machining a workpiece using a laser beam, the laser beam generated by a laser light source is focused or collimated onto the workpiece to be machined with the aid of beam guiding and focusing optics.

When machining at high laser powers, for example in the multi-kilowatt range, back reflections both on the optics or optical elements and on the workpiece may occur, which may lead to intense local heating of the housing or other components inside the housing. Often, the back reflections are so strong that the back reflections will damage or destroy the housing and/or other components of the laser machining head within the housing when hit. This may lead to discoloration on the housing surface or even to removal of material, which is deposited on optical elements arranged in the beam path of the laser beam, e.g. mirrors or lenses, thereby soiling them. The resulting increased absorption of laser radiation and heating can damage or even destroy the affected optical element.

Usually, attempts are made to solve this problem by providing the optical elements for the machining wavelengths with an anti-reflection coating with a high degree of absorption (e.g. greater than 99.5%) or low degree of reflection (e.g. less than 0.5%), so that the reflected laser power is so low that it does not cause any damage. It comes to a critical point here when optics, e.g. an F-Theta lens, consisting of a plurality of lenses and/or protective glasses are added. As a result, there are easily ten or more interfaces, all of which can contribute to the back reflections.

Apertures are often used to limit the cross-section or diameter of the laser beam or to absorb back reflections. In another approach, the components of the laser machining head are arranged in the housing in such a way that the focus of a back reflection originating from a curved surface is in the air, i. e. it does not hit and damage a surface in the optics space due to the high power density. However, this approach is extremely complicated and severely restricts the arrangement or construction of the laser machining head. For example, additional installation space is often necessary for this approach.

However, the strategy of providing the optical elements with anti-reflective coatings also has its limits since a certain reflectivity always remains, which, for higher laser powers, results in correspondingly higher back-reflection powers, so that, from a certain laser power, the back reflection may damage the housing and/or or components located therein. In addition, good anti-reflective coatings are complex and expensive so that there is a desire, particularly in the case of protective glasses which have to be replaced more frequently, to use anti-reflective coatings that are as simple and inexpensive as possible.

Other known approaches are based on active cooling devices. For example, EP 3 257 616 A shows a laser machining head with a cooling device for cooling optical components, the cooling device being connected to a gas duct and having at least one throttle for throttling the gas flow. EP 2 162 774 B1 shows a device for cooling at least one optical component using a flowing coolant that flows between the housing and a construction material. However, such active cooling devices require various connections, e.g. a power connection and/or coolant connection, in order to ensure the coolant flow. In addition, active cooling devices consume energy and/or coolant.

### SUMMARY OF THE INVENTION

It is an object of the present invention to protect the housing and/or components of the laser machining head arranged in the housing from damage by laser radiation. It is in particular an object of the present invention to protect the housing and/or the components of the laser machining head arranged therein from damage by laser radiation incident outside the beam path, for example due to back reflections of the laser beam.

These objects are achieved by the subject matter disclosed herein. Advantageous embodiments and further developments are also disclosed.

The present invention is based on the idea of spatially and/or temporally distributing and/or dissipating the energy introduced or incident in the housing and/or in the components arranged therein by laser radiation running outside the beam path, for example by back reflections of the laser beam. For this purpose, the laser machining head includes at least one (passive or active) overheat protection device comprising at least one (passive or active) energy distribution device for (spatially and/or temporally) distributing incident radiation energy and/or at least one (passive or active) heat sink for dissipating absorbed heat. In this way, the energy introduced cannot cause any damage and local overheating can be avoided. This is advantageous in particular in the case of laser machining heads for machining at high laser powers or at high laser pulse powers, i. e. at powers of more than 1 kW, in particular more than 10 kW.

According to an aspect of the present invention, a laser machining head for machining a workpiece with a laser beam comprises: a housing defining an optics space; at least one optical element arranged in the optics space, in particular for guiding and/or shaping the laser beam; and at least one overheat protection device configured to protect the housing and/or elements or components arranged in the housing from overheating, wherein the overheat protection device includes at least one energy distribution device for distributing incident radiation energy and/or at least one heat sink for receiving and/or dissipating heat, in particular for absorbing and/or dissipating heat generated by absorption of incident radiation energy. The overheat protection device may be an active overheat protection device, e.g. an active device for heat dissipation by means of a supplied coolant, or a passive or autarkic overheat protection device, i. e. an overheat protection device without a coolant connection or source and/or external energy supply.

The laser machining head may be a scanner laser machining head. In this case, the laser machining head may include a scanning device configured to direct the laser beam at different positions on the workpiece. The scanning device may be arranged in the housing. The part of the housing in which the scanning device is arranged or which encloses the scanning device may be referred to as the scanner housing. However, the laser machining head may also be a fixed optics laser machining head.

According to a further aspect of the present invention, a laser machining head for machining a workpiece by means of a laser beam comprises a scanning device for deflecting the laser beam on the workpiece; a housing (also called a scanner housing) in which the scanning device is arranged; and at least one overheat protection device configured to protect the housing from overheating, wherein the overheat protection device includes at least one energy distribution device for distributing incident radiation energy and/or at least one heat sink for absorbing and/or dissipating heat, in particular for absorbing and/or dissipating heat generated by absorption of incident radiation energy. The overheat protection device may be an active overheat protection device, e.g. an active device for heat dissipation by means of a supplied coolant, or a passive or autarkic overheat protection device, i. e. an overheat protection device without a coolant connection or source and/or external energy supply. The scanner housing may be integrated into a housing of the laser machining head or may be formed integrally or may form part of it. The housing and/or the scanner housing may define an optics space in which at least one optical element, in particular for guiding and/or shaping the laser beam, is arranged. The scanning device may be configured to direct the laser beam at different positions on the workpiece, in particular at positions in two mutually perpendicular directions.

The laser machining head according to one of these aspects may include one or more of the following features:

The housing of the laser machining head may have a modular structure. The scanner housing may form part of it. The housing of the laser machining head may define an optics space in which at least one optical element (in particular for guiding and/or shaping the laser beam) and/or the scanning device is/are arranged.

The scanning device may comprise at least one pivotable mirror. The scanning device preferably comprises two mirrors that can be pivoted about different axes. The laser machining head may also include an F-theta lens for focusing the laser beam. The F-theta objective may be arranged in the housing.

The scanning device, in particular the movable elements of the scanning device that deflect the laser beam, cause back reflections in different directions according to a position of the scanning device or according to a position of the movable elements of the scanning device that deflect the laser beam. The scanner laser machining head may further comprise an F-theta lens for focusing the laser beam. Since a surface of the F-theta lens facing the incident beam is relatively flat, back reflections with a high energy density occur on the F-theta lens. For these reasons, the overheat protection device according to the invention is of particular advantage in a scanner laser machining head.

Laser machining may include laser cutting, laser welding, laser ablation, or laser engraving. In other words, the laser machining head may be a laser cutting head, a laser welding head, a laser ablation head or a laser engraving head. In particular, the laser machining head (or the optical elements contained therein) may be configured for laser machining at high laser powers, i. e. more than 1 kW, or more than 10 kW, or even more than 20 kW.

The laser machining head may be a laser machining head for material machining with a short pulse laser beam or an ultra-short pulse laser beam. The overheat protection device according to the invention is particularly advantageous here since the production of suitable anti-reflective coatings for ultra-short pulses is even more complex and expensive due to the high spectral bandwidths and high peak intensities (pulse peak intensities).

The housing defines the optics space, i. e. the interior of the laser machining head, in which the at least one optical element and/or the scanning device is arranged. The optics space may be closed off or sealed from the outside, in particular dust-tight or even hermetically sealed. The at least one optical element arranged in the optics space or all of the optical elements arranged in the optics space may define the beam path of the laser machining head. In other words, the laser beam may be guided along the beam path through the at least one optical element arranged in the optics space or through all of the optical elements arranged in the optics space.

In particular, examples of elements or components arranged in the housing may include the at least one optical element, a holder for the optical element, an aperture, a motor shaft (e.g. of the scanning device), a minor mount or minor holder (e.g. of the scanning device), a shielding plate for electronics and the like.

The optical element may be an optical element for guiding and/or shaping the laser beam. The optical element may be or include a lens, a beam splitter, a minor, protective glass, an aperture, focusing optics, collimating optics, a movable scanning element, in particular a movable mirror, a scanning device for deflecting the laser beam and the like. The optical element may be movably arranged in the optics space. For example, the optical element may comprise a lens or lens group that can be displaced along the beam path or along its optical axis.

The overheat protection device is configured to protect the housing and/or elements arranged in the housing from (local) overheating, in particular due to laser radiation or due to absorption of incoming or incident laser radiation. In particular, laser radiation may be used to refer to laser radiation occurring outside of the (specified) beam path, for example back reflections of the laser beam on elements arranged in the housing and/or on the workpiece. The laser radiation may therefore arise unwantedly.

The at least one overheat protection device may be or include a passive or autarkic device. Therefore, no external connections, for example for energy or current supply or for supplying or removing a coolant or cooling medium or the like, are necessary. The laser machining head therefore remains as flexible as possible in terms of construction and mode of operation.

The at least one overheat protection device may be or comprise an active overheat protection device. The active overheat protection device may be a heat sink to dissipate heat. The active overheat protection device may, for example, comprise a cooling channel for cooling by means of a coolant flowing through the cooling channel. The cooling channel may be formed in the housing, i. e. in a wall of the housing. In particular, the cooling channel may be integrated in the scanner housing. In other words, the at least one overheat protection device may comprise an active overheat protection device with a cooling channel for conducting a coolant, said channel being formed in a wall of the housing. The active overheat protection device may further comprise a coolant connection for connecting the cooling channel to a coolant circuit. The coolant may be gas, air, liquid or water. The active overheat protection device may further comprise a pump or a fan or a controllable valve.

The overheat protection device includes a power distribution device and/or a heat sink. The energy distribution device is set up to distribute incident radiation energy or radiation intensity, in particular incident radiation energy or radiation intensity of laser radiation, e.g. of back reflections of the laser beam. The energy distribution device can be set up to distribute incident radiation energy or radiation intensity spatially and/or temporally. In this way, the energy absorbed by the housing or by an element arranged therein per area and time, i. e. the density of absorbed power per unit area, can be reduced. The heat sink is set up to absorb and/or dissipate heat, in particular heat generated by absorption of laser radiation or by absorption of back reflections of the laser beam. The heat sink can be set up to dissipate the heat, for example to the surroundings of the laser machining head, i. e. to an outside of the laser machining head.

The overheat protection device may be arranged in the optics space and/or on the inner surface of the housing and/or on at least one element arranged in the housing. The inner surface of the housing may at least partially define or surround the optics space. In particular, the overheat protection device may be arranged outside the laser beam path in the optics space. The overheat protection device may have at least one surface that adjoins the optics space or at least partially defines or delimits it. The overheat protection device may form part of the housing and/or be formed integrally with the housing. The overheat protection device may be attached to the housing, in particular in the housing.

The overheat protection device may be arranged in at least one predetermined critical position in the housing, at which the back reflections of the laser beam and/or laser radiation are incident. The critical position may be determined based on empirical values, calculation and/or simulation. In one embodiment, the overheat protection device may be arranged in the optics space in such a way that back reflections of the laser beam from the housing itself (i. e. from the inner surface of the housing) and/or from at least one element arranged in the housing, e.g. from an aperture stop, an optical element, an F-theta optics, a minor, a beam splitter, and/or a protective glass, hit the overheat protection device. For example, the overheat protection device may be arranged next to the optical element or adjacent to the optical element in the optics space in order to intercept back reflections on the optical element or so that back reflections from the optical element hit the overheat protection device. Additionally or alternatively, the overheat protection device may be formed on a holder of the optical element and/or form part of a holder of the optical element.

When the laser machining head includes a scanning device, the housing includes a scanner housing in which the scanning device is arranged. The scanner housing may form part of the housing or be part of the housing. In this case, the overheat protection device may be arranged in the scanner housing. The scanning device may be a galvo scanner or the like. The scanning device may comprise at least one mirror which can be pivoted about one or two axes, or two mirrors which can each be pivoted about one axis. The laser machining head may further comprise a focusing optics, for example an F-theta lens. The overheat protection device may be arranged in the housing, in particular in the scanner housing, opposite the focusing optics so that back reflections from the focusing optics hit the overheat protection device.

In one embodiment, the laser machining head may include a beam splitter, which is arranged in the beam path of the laser beam and is configured to let the laser beam pass. The overheat protection device may be arranged in the housing in such a way that a part of the laser beam reflected on the beam splitter hits the overheat protection device. The overheat protection device may thus be arranged in the housing adjacent to the beam splitter in a direction perpendicular to the propagation direction of the laser beam incident on the beam splitter. In other words, the overheat protection device may be arranged in such a way that radiation which is undesirably reflected at the beam splitter, i. e. which should actually have passed the beam splitter or should have passed through the beam splitter, hits the overheat protection device. The heat generated by absorption can thus be dissipated by the overheat protection device. This can prevent the housing from overheating.

In one embodiment, the laser machining head may comprise a beam splitter which is arranged in the beam path of the laser beam and is configured to reflect the laser beam. The overheat protection device may be arranged in such a way that a part of the laser beam that has passed through the beam splitter hits the overheat protection device. The overheat protection device may thus be arranged in the housing adjacent to the beam splitter in the propagation direction of the laser beam incident on the beam splitter. In other words, the overheat protection device may be arranged in such a way that radiation which undesirably passes through the beam splitter, i. e. which should actually have been reflected at the beam splitter, hits the overheat protection device. The heat generated by absorption can thus be dissipated by the overheat protection device. This can prevent the housing from overheating.

In one embodiment, the housing may include an entry port for coupling the laser beam into the laser machining head and collimating optics, with the overheat protection device being arranged between the entry port and the collimating optics. In this way, the overheat protection device can prevent local overheating of the housing adjacent to the entry port, e.g. due to fringe fields of the laser beam or due to excessive divergence of the coupled laser beam. The collimating optics may be an optical element arranged in the optics space. The collimating optics may comprise or be a lens or a lens group. The entry port may include a fiber coupler for coupling a fiber-guided laser beam.

The overheat protection device may include at least one energy distribution device for distributing incident radiation energy. The energy distribution device may comprise a dispersion element and/or a convex surface structure (hereinafter: convex structure) and/or a partially reflective surface.

The convex structure may be configured to spatially distribute incident radiation energy. The convex structure may have a curved and/or arched and/or conical and/or spherical surface protruding into the optics space. The convex structure may be composed of a large number of such surfaces. In other words, the convex structure may comprise periodically arranged and convex partial structures. The base of the partial structures may be honeycombed or rib-like. A period of the structure may correspond to a diameter of the incident back reflection and/or a diameter of the collimated laser beam. The convex structure may be formed on the inner surface of the housing and/or on a surface of an element arranged in the optics space. A surface on which laser radiation is incident is enlarged by the convex structure. The incident beam energy is thus distributed spatially and the power per unit area is reduced.

The convex structure may have a partially reflective surface. In this disclosure, partially reflective denotes a reflectance in a range from 40% to 95%, in particular from % to 80%. The partially reflective surface may be produced by surface treatment, e.g., by polishing or oxidizing, and/or by a surface coating. The spatial distribution of the incident radiation energy can be enhanced by the partial reflectivity. The radiation energy can thus be distributed more evenly and local peaks can be avoided.

The dispersion element can be set up to distribute incident radiation energy over time. The dispersion element may be configured to weaken laser radiation by dispersion, for example to weaken laser pulses or pulse-like back reflections or back reflections of laser pulses or to increase the chirp of the pulse. In other words, the dispersion element may be configured to increase a pulse duration and/or to reduce a pulse peak intensity. The dispersion element may be a refractive element. The dispersion element may be a glass plate. A laser pulse is usually polychromatic or has a broadband spectrum, i. e. laser pulses may have a large spectral bandwidth and/or high pulse peak intensities. When passing through the dispersion element, the pulse is broadened or weakened or the chirp of the pulse is increased due to the different speeds of the different wavelengths.

The dispersion element may be plate-shaped. The dispersion element may be arranged at a distance from the inner surface of the housing or from one of the elements arranged in the housing, so that incident laser radiation must first pass through the dispersion element in order to hit the inner surface or the element. The dispersion element or an optical surface of the dispersion element may extend in parallel to the inner surface of the housing. The dispersion element may be arranged in front of the convex structure (in the direction of the incident laser radiation). In other words, the dispersion element may be arranged in the optical space such that it overlaps with the convex structure and is spaced apart therefrom. In this way, laser radiation first passes through the dispersion element before it hits the convex structure.

The partially reflective surface may be configured to spatially distribute incident radiation energy. In this disclosure, partially reflective denotes a reflectance in a range from 40% to 95%, in particular from 50% to 80%. At least one surface in the optics space may be partially reflective. For example, the inner surface of the housing and/or a surface of an element arranged in the housing, for example a surface of a holder for an optical element and/or a surface of a holder for a movable element, may be formed to be partially reflective. For this purpose, the inner surface of the housing and/or the surface of an element arranged in the housing may be provided with a partially reflective coating. Alternatively, the inner surface of the housing and/or the surface of an element arranged in the housing may be made partially reflective by surface treatment. A partially reflective surface on a holder for a movable optical element, in particular a scanner mirror, is particularly advantageous since heat dissipation is particularly difficult in case of a movable optical element. A partially reflective surface is also particularly advantageous on a holder for a minor since minors are often glued and the adhesive softens or dissolves when the mirror holder is heated.

The overheat protection device may include at least one heat sink for absorbing and/or dissipating heat. The heat sink may comprise a cooling element and/or a solid piece of metal.

The heat sink may comprise a cooling element which has both a first surface located in the optics space for absorbing heat, in particular by absorbing incident laser radiation, and a second surface located on the outside of the housing or the laser machining head for dissipating the heat absorbed, in particular on an area surrounding the laser machining head. The cooling element may be integrated with the housing or form part of the housing. In other words, the cooling element may form both part of the inner surface of the housing and part of an outer surface of the housing or of the laser machining head. The second surface of the cooling element may be provided with cooling fins. As a result, a heat exchanging surface can be enlarged and heat dissipation to the surroundings can be improved.

The heat sink may comprise a solid piece of metal. The solid piece of metal may have a thickness of more than 5 mm, preferably more than 10 mm. The thickness of the solid piece of metal may indicate a dimension in a direction perpendicular to the inner surface of the housing. The solid piece of metal may be attached to the inner surface of the housing and cover part of the inner surface. The solid piece of metal may be in face-to-face contact with the inner surface of the housing. Alternatively, the solid piece of metal may be integral with or form part of the housing. The solid piece of metal may in particular be a milled housing part. For example, an inner surface of the housing part that forms part of the inner surface of the housing may be milled. For example, the solid piece of metal may be a scanner housing. This means that the scanner housing may be solid and thus form the heat sink.

The solid piece of metal may consist of copper and/or aluminum and/or copper alloys and/or aluminum alloys and/or a material with high thermal conductivity, i. e. a thermal conductivity of more than 50 W/m*K, in particular more than 100 W/m*K.

The heat sink may include a cooling channel arranged on the housing or in the housing, in particular in a housing wall, and a coolant connection for connecting the cooling channel to a coolant circuit. The coolant may be a fluid such as liquid, water, air or gas.

The at least one overheat protection device may comprise a combination of a passive overheat protection device and an active overheat protection device. The active overheat protection device may preferably be combined with at least one energy distribution device for distributing incident radiation energy and/or with at least one heat sink, in particular with at least one of the passive overheat protection devices described in this disclosure, e.g. with the convex structure and/or the dispersion element and/or the cooling element. The active overheat protection device may be located adjacent and/or adjoining to the energy distribution device for distributing incident radiation energy.

According to the present invention, attempts to reduce back reflections by means of complex anti-reflective coatings to such an extent that they cannot cause any damage are no longer made, but rather the areas of incidence of the back reflections are formed in such a way that they are not damaged even for back reflections of higher power. This also works for ultra-short pulses, for which the production of suitable anti-reflective coatings is even more difficult due to the high spectral bandwidths and high peak or pulse peak intensities. In addition, the configuration of an objective for a scanner laser machining head can be simplified since the formation of back reflections or their position within the scanner housing do not have to be taken into account to the same degree. For example, even the reflections from a plurality of interfaces may meet at one point on the housing without damaging it.

### BRIEF DESCRIPTION OF THE DRAWINGS

Exemplary embodiments of the disclosure are shown in the figures and are described in more detail below. In the figures:

FIG. 1 shows a schematic view of a laser machining head with an overheat protection device;

FIG. 2 shows a schematic view of another laser machining head with a scanning device and an overheat protection device according to the present invention;

FIGS. 3A to 3C show exemplary embodiments of an overheat protection device according to the present invention which is configured as an energy distribution device for distributing incident radiation energy;

FIGS. 4A to 4C show exemplary embodiments for an overheat protection device according to the present invention which is configured as a heat sink for dissipating heat;

FIGS. 5 to 10 show exemplary embodiments for preferred combinations of the overheat protection devices shown in FIGS. 3A to 3C and in FIGS. 4A to 4C; and

FIGS. 11 to 13 show exemplary embodiments for preferred combinations of the overheat protection devices shown in FIGS. 3A to 3C and in FIGS. 4A to 4C with a cooling channel.

### DETAILED DESCRIPTION OF THE INVENTION

Unless otherwise noted, the same reference symbols are used for identical elements and elements with the same effect below.

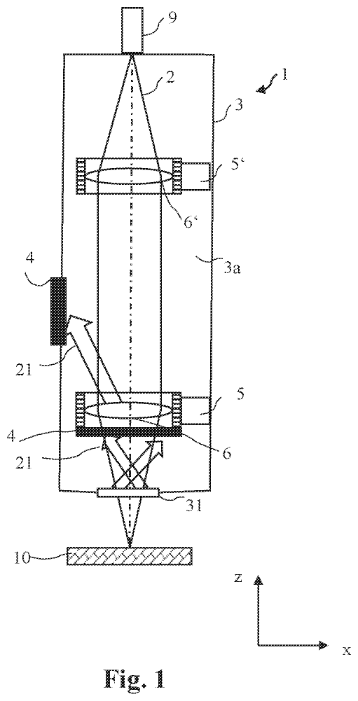

FIG. 1 shows a schematic representation of a laser machining head 1 for machining a workpiece 10 by means of a laser beam 2. The laser machining head 1 comprises a housing 3 which forms an optics space 3a. Furthermore, the laser machining head 1 comprises an optical fiber 9 for coupling the laser beam 2 into the laser machining head 1, an optics (or optical element) 6′, for example collimating optics for a collimating the laser beam 2, and an optics (or optical element) 6, for example a focusing optics 6 for focusing the laser beam 2. The optics 6′ and 6 are arranged in the optics space 3a and may each be attached to the housing 3 by means of an optics holder 5, 5′, for example. In particular, at least one of the optics holders 5, 5′ may be movably attached to the housing 3. The laser beam 2 emerges from the optics chamber 3a through a protective glass 31 and hits the workpiece 10. Even though FIG. 1 shows a linear fixed-optics laser machining head with a linear beam path, the laser machining head 1 may include a scanning device, i. e. it may be a scanner head and/or have an angled beam path.

Back reflections 21 of the laser beam 2 may occur on the protective glass 31, on the optics 6 and 6′ or on their holders 5, 5′. In order to protect the housing 3 from overheating due to absorption of the back reflections 21, the laser machining head 1 includes at least one overheat protection device 4 arranged in the optics space 3a, in particular outside the beam path of the (machining) laser beam 2. FIG. 1 shows an overheat protection device 4 arranged or attached on the inside or the inner surface of the housing 3 and an overheat protection device 4 arranged on the holder 5 of the optics 6 or forming part of the holder 5. The at least one overheat protection device 4 may also be integrated into the housing 3 or form part thereof. The at least one overheat protection device 4 is preferably arranged at a point on the housing 3 in the optics chamber 3a at which back reflections 21 of the laser beam 2 occur. Such critical points in the optics space 3a may be determined or specified, for example, by simulations, calculations or based on empirical values. However, it is also possible for the entire housing 3 to form the overheat protection device 4.

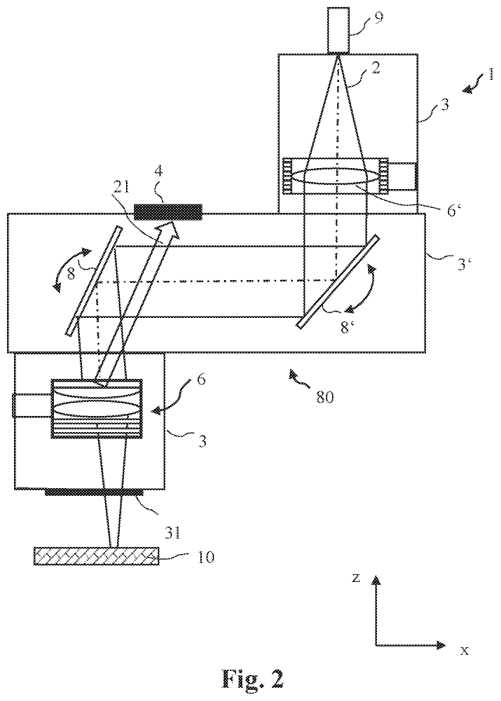

FIG. 2 shows a schematic view of a laser machining head 1 for machining the workpiece 10 by means of a laser beam 2 with a scanning device 80. The scanning device comprises at least one pivotable mirror. In the example shown in FIG. 2, the scanning device 80 comprises two mirrors 8, 8′, each pivotable about one axis. The laser beam 2 may be deflected to a plurality of different positions on the workpiece 10 by the scanner mirrors 8 and 8′. The laser beam 2 coupled into the laser machining head 1 via the optical fiber 9 passes through the optics 6′, for example a collimating optics, the scanning device with the two mirrors 8, 8′ and the optics 6, for example a focusing optics, which may in particular be a F-theta optics, and then exits the laser machining head 1 through the protective glass 31.

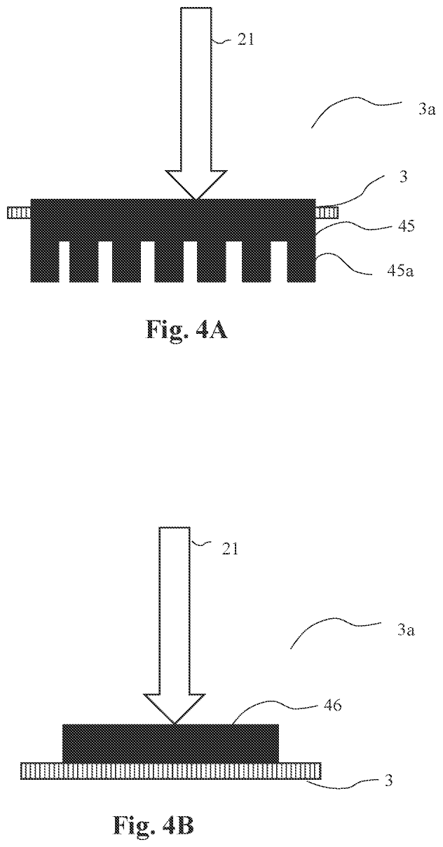

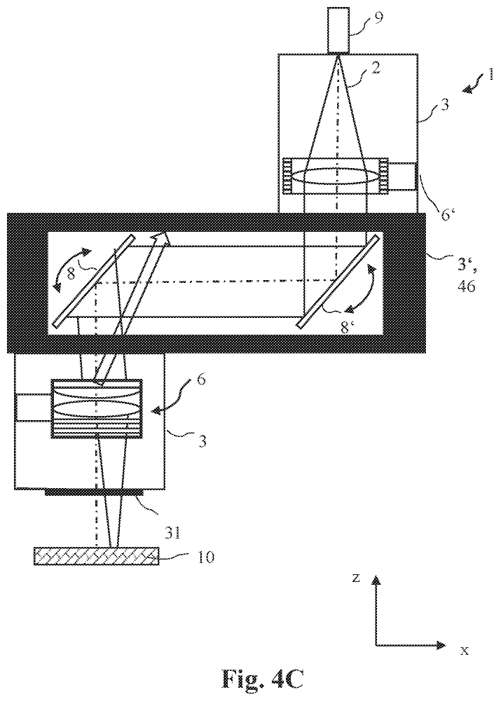

In the exemplary embodiment shown in FIG. 2, the housing is formed in a plurality of parts. In particular, the scanner housing 3′ may be formed separately. However, the present disclosure is not limited thereto. The scanner housing 3′ or the part of the housing in which the scanning device 80 is arranged may also be formed integrally with the rest of the housing 3 of the laser machining head. The scanning device 80 may be arranged in the scanner housing 3′. An overheat protection device 4 is arranged in the scanner housing 3′ at a predetermined critical point. Especially on flat optical elements, i. e. on optical elements with little curvature, there may be back reflections at high laser power. Back reflections 21 occur in particular on the optics 6, which in this exemplary embodiment is configured as an F-theta lens, and hit the scanner housing 3′. In order to protect the scanner housing 3′ from being damaged by overheating due to the back reflections 21, the laser machining head 1 includes at least one overheat protection device 4 arranged in the scanner housing 3′. The at least one overheat protection device 4 may be integrated in the scanner housing 3′ and/or in at least one of the housings 3 or may form part of the same. It is also possible to configure the entire scanner housing 3′ as an overheat protection device 4. This is described below with reference to FIG. 4C.

The overheat protection device 4 according to the present invention may be a passive device, i. e. independent of an external energy and/or coolant supply, and serves to protect the housing or elements arranged in the housing from overheating due to laser radiation propagating outside the beam path, such as such as back reflections. The overheat protection device 4 may be configured as a energy distribution device for distributing incident radiation energy or as a heat sink for dissipating heat generated by incident radiation energy. For this purpose, various embodiments and combinations thereof are possible.

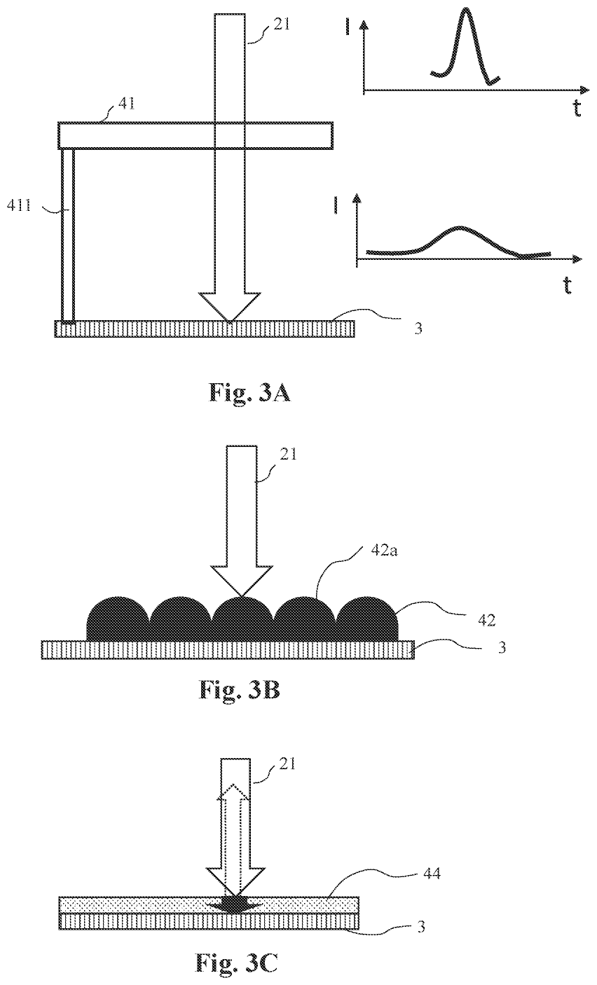

FIGS. 3A to 3C show exemplary embodiments of a passive overheat protection device according to the present invention configured as an energy distribution device for distributing incident radiation energy, in particular for spatially or temporally distributing incident radiation energy.

FIG. 3A illustrates an overheat protection device 4 configured as a dispersion element 41 for attenuating laser pulses and/or laser radiation with a broadband spectrum. In order to achieve a change in the energy distribution over time, particularly in the case of laser machining using ultra-short pulses, a dispersion element 41 or a refractive element (e.g. a glass plate) may be arranged at a critical point in the housing 3. This increases the “chirp” of the pulse, which results in a longer pulse duration and a lower peak intensity or pulse peak intensity of the pulse. Laser radiation or back reflections 21 propagating outside the beam path must pass through the dispersion element 41 before they can hit the critical point. As illustrated in FIG. 3A as an intensity distribution before and after passage through the dispersion element 41, a pulse-like back reflection 21 or pulse-like laser radiation is spread over time by the dispersion element 41 and is thereby weakened.

The dispersion element 41 may be fixed at a distance from an inner surface of the housing 3 by a suspension 411 in the housing 3, in particular on an inner surface of the housing 3. An optical surface of the dispersion element 41 may extend in parallel to the inner surface of the housing 3. However, the dispersion element 41 may also be fastened to an element arranged in the housing 3 and at a distance therefrom by the suspension 411.

FIG. 3B shows an overheat protection device 4 which is in the form of a convex structure 42. The convex structure 42 is configured to spatially distribute laser radiation or back reflections 21. Due to the convexity, the incident laser radiation is distributed over a larger surface. The convex structure 42 may be arranged in the housing 3, in particular on the inner surface of the housing 3. The convex structure 42 may be attached to the housing 3, in particular in contact with the housing 3 (see FIG. 3B). Alternatively, the convex structure 42 may be formed integrally with the housing 3. In particular, a scanner housing 3′, i. e. a housing for accommodating the scanner mirrors 8 and 8′, may have a patterned surface or the convex structure on the inside in order to distribute back reflections over the largest possible area. In addition or as an alternative, internal components such as motor shafts, mirror receptacles, shielding plates for electronics, etc. (not shown) may also be provided with the convex structure 42.

As shown in FIG. 3B, the convex structure 42 may comprise a plurality of periodically arranged partial structures 42a. In this case, a period of the convex structure 42 may approximately correspond to a diameter of the back reflection 21. The diameter of the back reflection 21 is often of the same order of magnitude as the diameter of the collimated laser beam 2, i. e. the period of the convex structure 42 may be chosen according to the known diameter of the collimated laser beam 2.

FIG. 3C shows an overheat protection device 4 with a partially reflective surface 44, by which the back reflection 21 is only partially absorbed or reflected back into the optics space 3a of the housing 3. The partially reflective surface 44 may be formed by a coating or by surface treatment. For example, the partially reflective surface 44 may be arranged on the inner surface of the housing 3 or form a part thereof. In particular, a scanner housing 3′, i. e. a housing for accommodating the scanner minors 8 and 8′, may have the partially reflective surface 44 so that only part of the back reflection is absorbed at the point of incidence, but the rest is reflected away or scattered to other points to be absorbed in the housing. In this way, it can be achieved that energy of the back reflection 21 is no longer deposited at one point in the housing, but is distributed as evenly as possible in the optics space 3a of the housing 3 and/or on the housing 3 and thus does not cause any damage. To this end, it may be advantageous for the partially reflective surface 44 to have a specific structure, for example like the convex structure 42 described above, so that the scattering covers the largest possible solid angle. A period of the structure may roughly correspond to a diameter of the back reflection 21, which is often in the same order of magnitude as the diameter of the collimated laser beam 2. Other internal components (i. e. arranged in the optics space 3a) such as motor shafts, mirror receptacles, shielding plates for electronics, etc, may be provided with the partially reflective surface 44.

FIGS. 4A to 4C show exemplary embodiments of a passive overheat protection device 4 according to the present invention, which is configured as a heat sink for dissipating heat, in particular heat that stems from the absorption of back reflections or laser radiation propagating outside the beam path.

FIG. 4A shows an overheat protection device 4 configured as a cooling element 45 for dissipating heat from the housing 3 or the optics space 3a. The cooling element 45 has a first surface arranged in the optics space for absorbing heat and a second surface arranged on an outside of the housing 3 for dissipating the absorbed heat. The second surface may include a plurality of cooling fins 45a. For example, the cooling element 45 is attached to a side of the housing 3 outside the optics space 3a. The cooling element 45 may also be integrated into the housing 3. The first surface of the cooling element 45 may form part of the inner surface of the housing 3. The second surface of the cooling element 45 may form part of an outer surface of the housing 3. The cooling element 45 may be integrated into the housing 3 or may form part thereof.

FIG. 4B shows an overheat protection device 4 which is in the form of a solid piece of metal 46. The solid piece of metal 46 may be attached in the housing 3, and in particular on the housing 3 within the optics space 3a. The solid piece of metal 46 may cover part of the inner surface of the housing 3. In particular, the solid metal piece 46, for example in the form of solid copper or aluminum pieces, may be deliberately attached at at least one previously known critical point in the optics space 3a, i. e. at which the back reflections 21 are critical.

Alternatively, the solid piece of metal 46 may be formed integrally with the housing 3 or form part of the housing 3. In particular, as shown in FIG. 4C, a scanner housing 3′ may be solid. A material with high thermal conductivity, i. e. a thermal conductivity greater than 50 W/m*K, in particular greater than 100 W/m*K, may be used for this. For example, the scanner housing 3′ may consist, at least for the most part, of copper and/or aluminum and/or copper alloy and/or aluminum alloy. In this way, the heat introduced by the back reflection can be distributed and dissipated as quickly as possible. The scanner housing 3′ may be a solid piece of metal 46, for example, from which at least part of the optics space 3a is milled. In this case, a thickness or wall thickness of the scanner housing 3′ may be more than 5 mm, preferably more than 10 mm.

The solid piece of metal 46 may have a thickness of more than 5 mm, preferably more than 10 mm. The solid piece of metal 46 may consist of a material with high thermal conductivity, i. e. a thermal conductivity greater than 50 W/m*K, in particular greater than 100 W/m*K. In particular, the solid piece of metal 46 may consist of copper and/or aluminum and/or copper alloy and/or aluminum alloy. As a result, heat introduced into the solid piece of metal 46 by back reflections 21 can be distributed as quickly as possible in the solid piece of metal 46 and dissipated from the solid piece of metal 46.

While it is not specifically shown, the scanner housing 3′ may additionally or alternatively be provided with an active overheat protection device. For example, a cooling channel 43 for cooling by means of a coolant may be formed in a wall of the scanner housing 3′. The cooling channel 43 may be provided with a coolant connection for connecting to a coolant circuit.

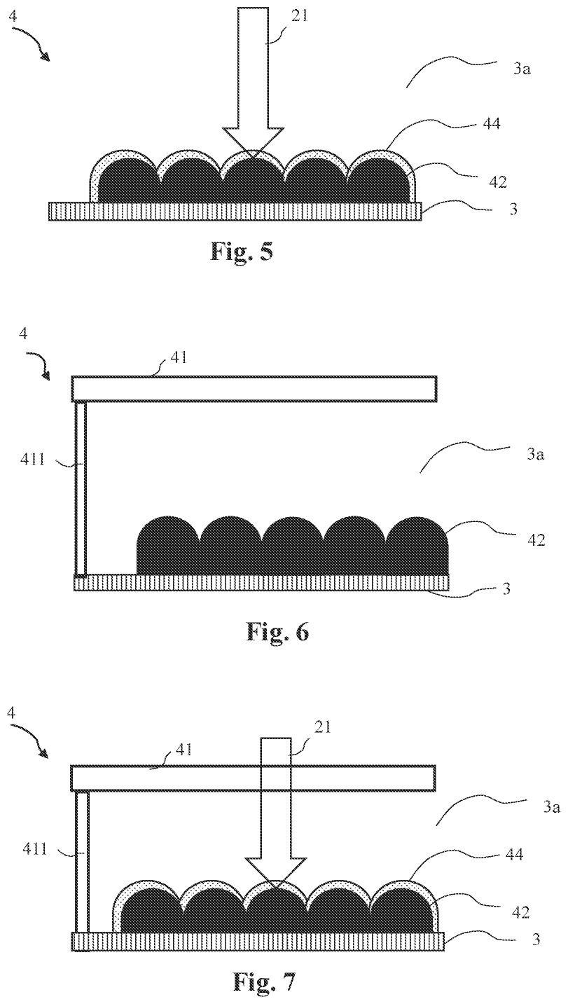

FIGS. 5 to 10 show combinations of the above-described embodiments of overheat protection devices.

However, the combinations shown in FIGS. 5 to 10 are by no means to be regarded as complete. It is hereby expressly pointed out that any combination of the overheat protection devices 4 shown in FIGS. 3A to 3C and in FIGS. 4A to 4C or described in the description of these figures is possible.

FIG. 5 shows a convex structure 42 with a partially reflective surface 44. The partially reflective surface 44 may be applied to the convex structure 42 by coating or formed thereon by surface treatment. As a result, scattering over the largest possible solid angle may be achieved.

FIG. 6 shows a combination of the convex structure 42 with the dispersion element 41. The dispersion element 41 overlaps the convex structure 42 (i. e. in a direction perpendicular to an optical surface of the dispersion element 41) and is spaced from the convex structure 42 by the suspension 411. In this way, both a spatial and a temporal distribution of incident radiation energy can be achieved.

FIG. 7 shows a combination of the partially reflective surface 44 on the convex structure 42 with the dispersion element 41. The partially reflective surface 44 is applied to the convex structure 42. The dispersion element 41 is arranged at a certain distance in front of the convex structure 42 by the suspension 411.

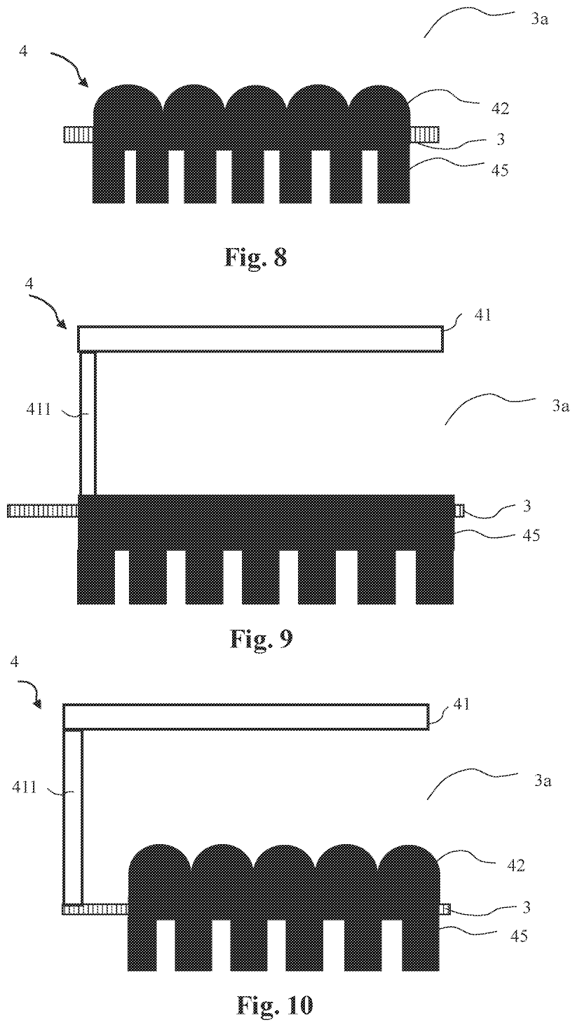

FIG. 8 shows a combination of the cooling element 45 and the convex structure 42. In this case, the first surface of the cooling element 45 may have the convex structure 42.

FIG. 9 shows a combination of the cooling element 45 and the dispersion element 41. The cooling element 45 overlaps with the dispersion element 41. In other words, the dispersion element 41 is attached in such a way that back reflections incident on the cooling element 45 must pass through the dispersion element 41. Thus, the dispersion element 41 at least partially shields the cooling element 42. Due to the temporal spread of incident radiation energy due to the dispersion element, the cooling element 45 can dissipate the heat generated to the outside or to the surroundings of the laser machining head more reliably. In particular, intensity peaks that can lead to ablation effects are avoided or at least reduced.

FIG. 10 shows a combination of the cooling element 45, the dispersion element 41 and the convex structure 42. The cooling element 45 overlaps the convex structure 42. In other words, the dispersion element 41 is attached in such a way that back reflections incident on the convex structure 42 have to pass the dispersion element 41. The dispersion element 41 thus shields the convex structure 42 at least partially. The heat absorbed by the convex structure 42 can be dissipated quickly and efficiently to the outside or to the surroundings of the laser machining head by the cooling element.

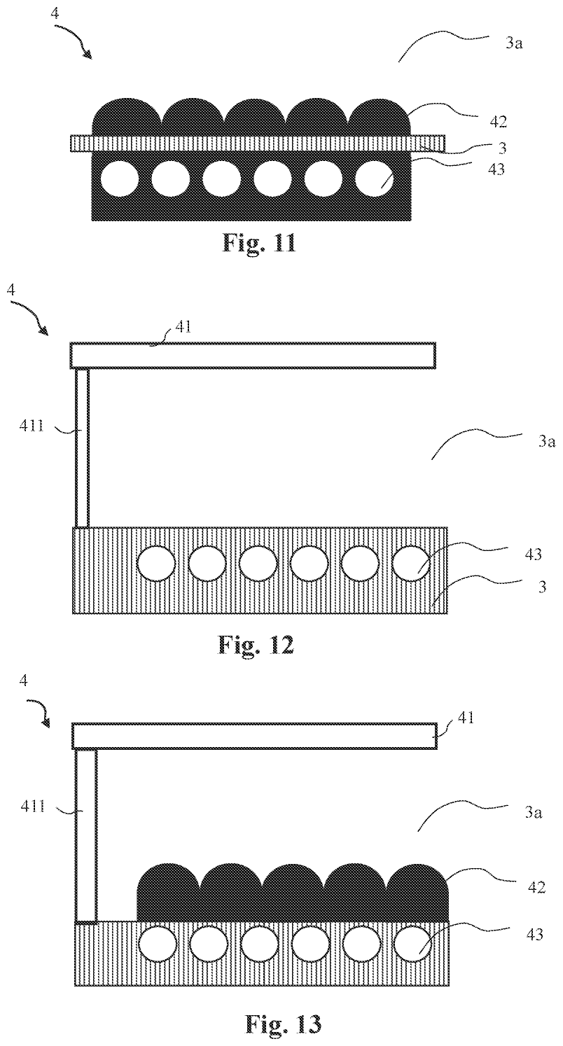

FIGS. 11 to 13 show exemplary embodiments for a combination of an active and at least one passive overheat protection device according to the present invention. The active overheat protection device may include at least one cooling channel 43 through which a cooling medium or coolant, such as a gas or a liquid, flows. The cooling channel 43 may be connected to a coolant circuit via a coolant connection. Ideally, the cooling channel 43 is attached spatially close to the areas on which the back reflections 21 hit. The active overheat protection device may also include a pump or a fan or a controllable valve.

FIG. 11 shows a combination of a cooling channel 43 and the convex structure 42. The at least one cooling channel 43 is arranged adjacent to the convex structure 42. The at least one cooling channel 43 may be arranged on the housing 3 outside of the optics space 3a. However, the cooling channel 43 may also be arranged within the housing 3 or be integrated into the housing 3 (cf. FIG. 12).

FIG. 12 shows a combination of a cooling channel 43 and the dispersion element 41. The cooling channel 43 may be arranged in an area of the housing 3 in which back reflections that have passed through the dispersion element 41 are incident. The cooling channel 43 may be arranged within the housing 3 or be integrated into the housing 3. However, the cooling channel 43 may also be arranged outside of the optics space 3a.

FIG. 13 shows a combination of a cooling channel 43, the dispersion element 41 and the convex structure 42.

According to the present invention, areas of the housing or areas in the housing or in the optics room which may be affected by back reflections can be provided with overheat protection devices and thus be configured in such a way that they can dissipate the energy introduced without being damaged. In particular in the case of scanner laser machining heads, in which high laser powers are used, or in ablation laser machining processes in which high pulse powers are used, damage due to laser radiation propagating outside the beam path, such as back reflections, can be reduced or even prevented.

### LIST OF REFERENCE SYMBOLS

1 laser machining head
2 laser beam
21 back reflection
3 housing
3′ scanner housing
3a optics space
31 protective glass
4 overheat protection device
41 dispersion element
411 suspension
42 convex structure
43 cooling channel
44 partially reflective surface
45 cooling element
45a cooling fin
46 solid piece of metal
5 optics holder
6, 6′ optics
8, 8′ scanner mirror
80 scanning device
9 optical fiber
10 workpiece

1. A laser machining head for machining a workpiece by a laser beam, comprising:
a scanning device for deflecting the laser beam on the workpiece;
a housing in which the scanning device is arranged; and
at least one overheat protection device, configured to protect the housing from overheating,
wherein the overheat protection device comprises an energy distribution device for distributing incident radiation energy and/or a heat sink for dissipating heat.

2. The laser machining head according to claim 1, wherein:
the at least one overheat protection device comprises an active overheat protection device with a cooling channel for conducting a coolant; and
the cooling channel is formed in a wall of the housing.

3. The laser machining head according to claim 1, wherein:
the overheat protection device is arranged in the housing and/or outside a beam path of the laser beam and/or on an inner surface of the housing and/or on at least one element arranged in the housing; and/or
the overheat protection device forms part of the housing and/or is formed so as to be integrated with the housing.

4. The laser machining head according to claim 1, wherein the overheat protection device is arranged at a predetermined critical position in the housing), at which back reflections of the laser beam and/or laser radiation propagating outside of a beam path of the laser beam are incident.

5. The laser machining head according to claim 1, wherein the overheat protection device is arranged next to an optical element arranged in the housing and/or formed on a holder of an optical element arranged in the housing and/or forms a part of a holder of an optical element.

6. The laser machining head according to claim 1, wherein the overheat protection device is arranged in the housing in such a way that back reflections of the laser beam from at least one optical element arranged in the housing, in particular from an aperture stop, an optical element, an F-theta optics, a minor, a beam splitter, and/or a protective glass, hit the overheat protection device.

7. The laser machining head according to claim 1, wherein:
the housing includes an entry port for coupling the laser beam into the laser machining head and a collimating optics; and
the overheat protection device is arranged between the entry port and the collimating optics.

8. The laser machining head according to claim 1, wherein:
the overheat protection device comprises an energy distribution device for distributing incident radiation energy; and
the energy distribution device comprises a convex structure.

9. The laser machining head according to claim 8, wherein the convex structure comprises a plurality of periodically arranged and convex partial structures and/or has a partially reflective surface.

10. The laser machining head according to claim 1, wherein:
the overheat protection device comprises an energy distribution device for distributing incident radiation energy; and
the energy distribution device comprises a dispersion element for attenuating laser pulses and/or laser radiation with a broadband spectrum.

11. The laser machining head according to claim 1, wherein:
the overheat protection device comprises a heat sink for dissipating absorbed heat; and
the heat sink comprises a cooling element which has both a first surface arranged in the housing for absorbing heat and a second surface arranged on an outside of the housing for dissipating the absorbed heat.

12. The laser machining head according to claim 1, wherein:
the overheat protection device comprises a heat sink for dissipating absorbed heat; the heat sink comprises a solid piece of metal attached to the housing and covering a part of the inner surface thereof or forming part of the housing; and
the solid piece of metal has a thickness of more than 5 mm, preferably more than 10 mm.

13. The laser machining head according to claim 12, wherein the solid piece of metal consists of copper and/or aluminum and/or copper alloys and/or aluminum alloys and/or a material with a thermal conductivity greater than 50 W/m*K, in particular greater than 100 W/m*K.

14. The laser machining head according to claim 1, wherein at least part of an inner surface of the housing and/or at least part of a surface of an element arranged in the housing is configured to be partially reflective.

15. A laser machining head for machining a workpiece by a laser beam, comprising: a housing defining an optics space; and
at least one passive overheat protection device, configured to protect the housing and/or elements arranged in the housing from overheating,
wherein the overheat protection device comprises an energy distribution device for distributing incident radiation energy and/or a heat sink for dissipating heat.

16. The laser machining head according to claim 15, further comprising an active overheat protection device with a cooling channel for conducting a coolant, said cooling channel being formed in a wall of the housing.

17. The laser machining head according to claim 15, wherein:
the overheat protection device is arranged in the housing and/or outside a beam path of the laser beam and/or on an inner surface of the housing and/or on at least one element arranged in the housing; and/or
the overheat protection device forms part of the housing and/or is formed so as to be integrated with the housing.

18. The laser machining head according to claim 15, wherein the overheat protection device is arranged at a predetermined critical position in the housing), at which back reflections of the laser beam and/or laser radiation propagating outside of a beam path of the laser beam are incident.

19. The laser machining head according to claim 15, wherein the overheat protection device is arranged next to an optical element arranged in the housing and/or formed on a holder of an optical element arranged in the housing and/or forms a part of a holder of an optical element.

20. The laser machining head according to claim 15, wherein the overheat protection device is arranged in the housing in such a way that back reflections of the laser beam from at least one optical element arranged in the housing, in particular from an aperture stop, an optical element, an F-theta optics, a mirror, a beam splitter, and/or a protective glass, hit the overheat protection device.
